(19) United States
(12) Patent Application Publication
(10) Pub. No.: US 2010/0082573 A1
(43) Pub. Date: Apr. 1, 2010

(54) DEEP-CONTENT INDEXING AND CONSOLIDATION

(75) Inventors: Fabrice CANEL, Redmond, WA (US); Aaron Michael GETZ, Seattle, WA (US); Kemp Crockett PETERSON, Seattle, WA (US); Robert Michael DOLIN, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/235,798

(22) Filed: Sep. 23, 2008

(51) Int. Cl. G06F 17/30

(52) U.S. Cl. 707/706; 707/E17.084

(57) ABSTRACT

Methods in computer-readable media for searching a large volume of documents is provided. In embodiments, the plurality of related documents are consolidated by a web host into a synthetic search document. The synthetic search document includes a set of descriptive information for each web page consolidated into the synthetic search document. Each set of descriptive information is associated with a subpart identifier that includes information that allows a search engine to provide a link to navigate to an individual document. Web pages consolidated into a synthetic search document may be edited to include an indication that that web page is not to be individually searched or indexed by a search engine. Similarly, the synthetic search document may be designated as a synthetic search document by information included on it.

### BACKGROUND

Internet search engines find documents that are responsive to a query by comparing the content of the query to the content in various documents. Search engines may build an index using a web crawler that goes from page to page on the Internet and records the links on the page along with a description of document content. Once the index is built, it can be used to retrieve a document that matches a query.

### SUMMARY

This summary is provided to introduce a selection of concepts in a simplified form that are further described below in the Detailed Description. This summary is not intended to identify key features or essential features of the claim subject matter, nor is it intended to be used as an aid in determining the scope of the claim subject matter.

Embodiments of the present invention generally relate to consolidating content found in multiple related documents (e.g., web pages) into a single synthetic search document for the purpose of presenting descriptions of the multiple documents to a search engine. The search engine may then search and index one document (i.e., the synthetic search document) instead of indexing each of the multiple documents. In one embodiment, the multiple documents are excluded from separate indexing by adding a meta or http header data tag to each of the multiple documents that indicates to a search engine the multiple documents are not to be indexed. In one embodiment, the multiple documents consolidated into the synthetic search document are related to each other. For example, the documents may be related based on association with a single user, a common subject matter, or combination of factors. Supplemental information that describes all of the related pages may be added to this synthetic search document without modifying any of the consolidated documents. A search engine may be programmed to understand the various meta data tags and take advantage of the supplemental information included in the synthetic documents. The synthetic search document includes subpart identifiers that allow a search engine to locate the document associated with the subpart identifier.

### BRIEF DESCRIPTION OF THE DRAWINGS

The present invention is described in detail below with reference to the attached drawing figures, wherein:

FIG. 1 is a block diagram of an exemplary computing environment suitable for implementing embodiments of the present invention;

FIG. 2 is a block diagram illustrating a network architecture suitable for use with embodiments of the present invention;

FIG. 3 is web page hierarchy used to illustrate embodiments of the present invention;

FIG. 4 is a flow chart showing a method of preparing a plurality of related documents to be searched by a search engine in accordance with an embodiment of the present invention;

FIG. 5 illustrates a synthetic search document generated in accordance with an embodiment of the present invention;

FIG. 6 illustrates a synthetic search document site map showing synthetic search documents combining documents associated with an individual user in accordance with an embodiment of the present invention;

FIG. 7 illustrates a synthetic search document site map showing synthetic search documents combining documents associated with a common subject matter user in accordance with an embodiment of the present invention;

FIG. 8 illustrates a synthetic search document site map showing synthetic search documents combining documents associated with an individual user and a common subject matter in accordance with an embodiment of the present invention;

FIG. 9 is a flow chart illustrating a method of locating information within a plurality of related documents in accordance with an embodiment of the present invention; and

FIG. 10 is a flow chart illustrating a method of preparing a plurality of related web pages in a social networking web site to be searched by a search engine in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Accordingly, in one embodiment, one or more computer-readable media having computer-executable instructions embodied thereon for performing a method of preparing a plurality of related documents to be searched by a search engine is provided. Each of the plurality of related documents is reachable by a unique identifier. The method includes, for each of the plurality of related documents, deriving a set of descriptive information that describes content in one of the plurality of related documents, thereby resulting in a plurality of descriptive information sets that includes a separate set of descriptive information for each of the plurality of related documents. The method also includes, for each of the plurality of related documents, generating a subpart identifier that contains navigation information that allows the search engine to navigate to an individual related document associated with the subpart identifier. The subpart identifier does not contain a URL, thereby resulting in a plurality of subpart identifiers that includes a separate subpart identifier for each of the plurality of related documents. The method further includes integrating the plurality of descriptive information sets and the plurality of subpart identifiers into a synthetic search document. The synthetic search document is a single document that contains multiple subparts. Each subpart includes an individual set of descriptive information paired with a single subpart identifier that contains the navigation information for an individual document from which the individual set of descriptive information is derived.

In another embodiment, one or more computer-readable media having computer-executable instructions embodied thereon for performing a method of locating information within a plurality of related documents is provided. Each of said plurality of related documents includes an ability to be separately reachable by a unique identifier. The method includes receiving a search query and determining that a set of descriptive information within a synthetic search document matches the search query. The synthetic search document is a single document that contains a subpart for each of the plurality of related documents, thereby forming a plurality of subparts. Each subpart includes an individual set of descriptive information that describes content in one related document and an associated subpart identifier that contains navigation information that allows a search engine to navigate to the one related document. The method also includes presenting search results that include a link to an individual document from which said set of descriptive information is derived by using the navigation information in an individual subpart identifier associated with the set of descriptive information to generate the link.

In yet another embodiment, one or more computer-readable media having computer-executable instructions embodied thereon for performing a method of preparing a plurality of related web pages in a social networking web site to be searched by a search engine is provided. Each of the plurality of related web pages includes an ability to be separately reachable by a unique identifier. The method includes, for each of the plurality of related web pages in the social networking web site, deriving a set of descriptive information that describes content in one of the plurality of related web pages, thereby resulting in a plurality of descriptive information sets that includes a separate set of descriptive information for each of the plurality of related web pages. Each of the plurality of related web pages includes a common subject matter. The method further includes, for each of the plurality of related web pages, generating a subpart identifier that contains navigation information that allows the search engine to navigate to an individual related web page associated with the subpart identifier, thereby resulting in a plurality of subpart identifiers that includes a separate subpart identifier for each of the plurality of related web pages. The method further includes, integrating the plurality of descriptive information sets and the plurality of subpart identifiers into a synthetic search document. The synthetic search document is a single document that contains multiple subparts. Each subpart includes an individual set of descriptive information paired with a single subpart identifier that contains the navigation information for an individual web page from which the individual set of descriptive information is derived. The method further includes adding information to each of the plurality of related web pages that indicates to the search engine that each of the plurality of related web pages should not be individually indexed, thereby enabling the search engine to respond to a query by searching said synthetic search document rather than each of the plurality of related web pages.

Having briefly described an overview of embodiments of the present invention, an exemplary operating environment suitable for use in implementing embodiments of the present invention is described below.

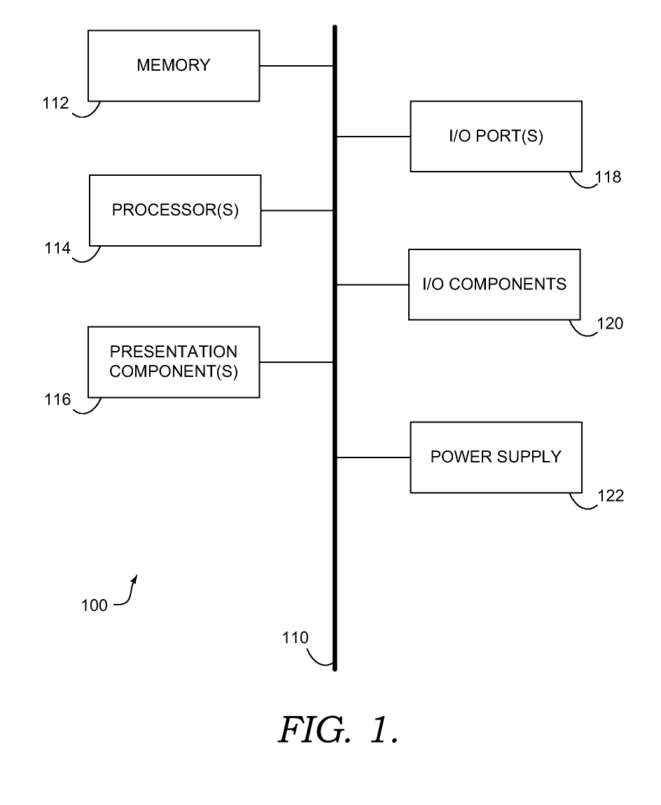

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

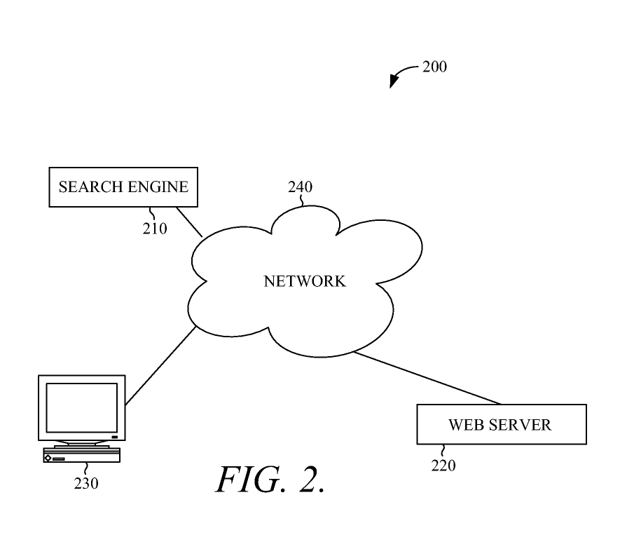

Turning now to FIG. 2, a block diagram depicting a networking architecture 200 is shown for use in implementing an embodiment of the present invention. The networking architecture 200 comprises, search engine 210, web server 220, and client computing device 230, all of which communicate with each other via network 240. Networking architecture 200 is merely an example of one suitable networking environment and is not intended to suggest any limitation as to the scope of use or functionality of the present invention. Neither should networking architecture 200 be interpreted as having any dependency or requirement related to any single component or combination of components illustrated therein. For example, the present invention may be practiced entirely on a single computing device that is not connected to network 240

Search engine 210 is a combination of hardware and software. The hardware aspect includes a computing device that includes a CPU, short-term memory, long-term memory, and one or more network interfaces. A network interface is used to connect to network 240. The network interface could be wired, wireless, or both. Software on the search engine 210 communicates with other computers connected to network 240. The software facilitates searching available documents, such as web pages, stored on the computers connected to the network. In one embodiment, the search engine builds an index that includes keywords describing the searched documents along with location information indicating how to locate the searched documents. For example, the location information may include a uniform resource locator (“URL”). The search engine may search the computers connected to the network using a web crawler that automatically opens the documents and analyzes the content. The web crawler may track the documents it visited.

The search engine 210 may present a search document over network 240 that is capable of receiving search queries from users. The search engine 210 then identifies documents that match the query and transmits a page of search results back to the requesting user. The search engine includes a variety of computer-readable media and the ability to access and execute instructions contained on the media. The above description of hardware and software is illustrative only. Many other features of search engine 210 are not listed so as to not obscure embodiments of the present invention.

Web server 220 is a combination of hardware and software. The hardware aspect includes a computing device that includes a CPU, short-term memory, long-term memory, and one or more network interfaces. A network interface is used to connect to network 240. The network interface could be wired, wireless, or both. Software on the web server 220 communicates with other computers connected to network 240. The software facilitates transmitting requested web pages to a requesting computer device, such as client computing device 230. The web server 220 may store large numbers of web pages. The web pages hosted by the web server 220 may be searched and indexed by the search engine 210. The above description of hardware and software is illustrative only. Many other features of a search engine 210 are not listed so as to not obscure embodiments of the present invention.

It will be understood by those of ordinary skill in the art that networking architecture 200 is merely exemplary. While the search engine 210 and web server 220 are illustrated as single boxes, one skilled in the art will appreciate that they are scalable. For example, the web server 220 may in actuality include multiple boxes in communication. The single unit depictions are meant for clarity, not to limit the scope of embodiments in any form.

The client computing device 230 may be a type of computing device, such as device 100 described above with reference to FIG. 1. The client computing device 230 includes a display device capable of displaying documents, web pages, and other items. By way of example only and not limitation, the client computing device 230 may be a personal computer, desktop computer, laptop computer, handheld device, cellular phone, consumer electronic, digital phone, smartphone, PDA, or the like. It should be noted that embodiments are not limited to implementation on such computing devices. In one embodiment, a search query is submitted by client computing device 230 to search engine 210 over a user interface presented by the search engine 210. A list of search results may be returned to the client device and displayed on the display device associated with the client computing device 230.

Network 240 may include a computer network or combination thereof. Examples of networks configurable to operate as network 240 include, without limitation, a wireless network, landline, cable line, digital subscriber line (“DSL”), fiber-optic line, local area network (“LAN”), wide area network (“WAN”), metropolitan area network (“MAN”), or the like. Network 280 is not limited, however, to connections coupling separate computer units. Rather, network 220 may also comprise subsystems that transfer data between servers or computing devices. For example, network 240 may also include a point-to-point connection, the Internet, an Ethernet, an electrical bus, a neural network, or other internal system.

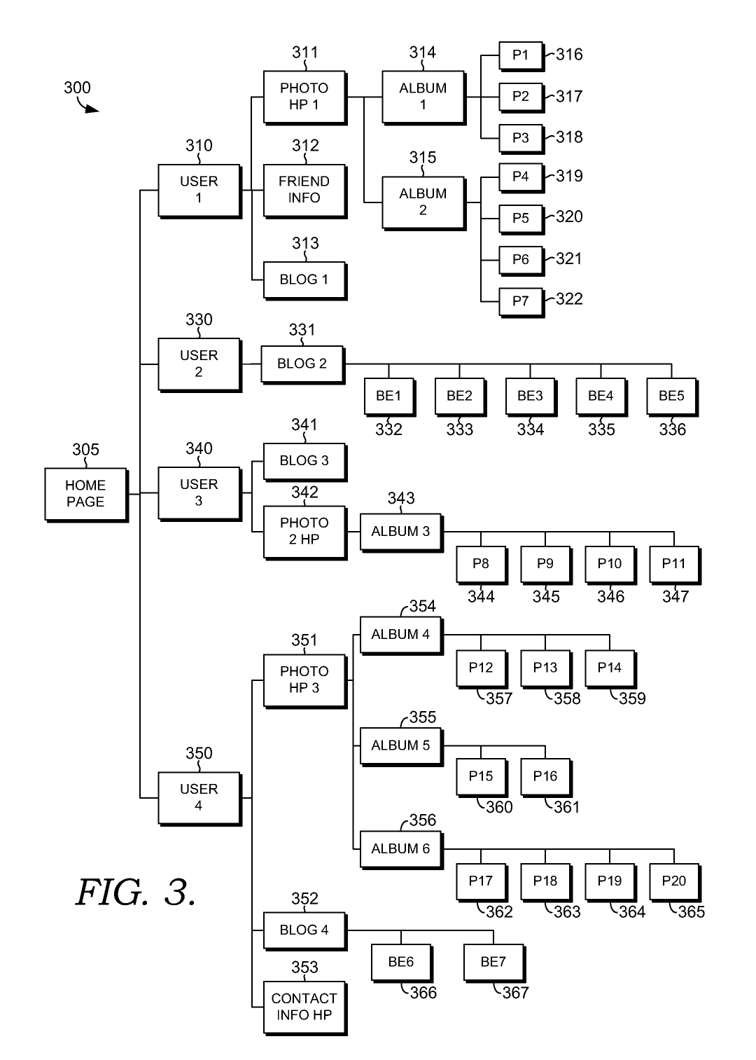

Turning now to FIG. 3, a web page hierarchy 300 is shown. The web page hierarchy 300 is used in examples given throughout this description. The web page hierarchy 300 could form a small part of a social network site. However, embodiments in the present invention are not limited to social networking sites. Further, the number of web pages shown in the web page hierarchy 300 is necessarily limited for the sake of illustration herein. In an actual embodiment, millions of web pages could be manipulated as part of embodiments of the present invention.

Web page hierarchy 300 includes a homepage 305. The homepage 305 may be described as the root node of the web page hierarchy 300. All other web pages may be described as child nodes of homepage 305. The homepage 305 links to four user pages associated with user's 1, 2, 3, and 4. The user pages may be home pages for a user's profile. The user pages include “user page 1” 310, “user page 2” 330, “user page 3” 340, and “user page 4” 350. “User page 1” 310 links to “photo homepage 1” 311. “Photo homepage 1” 311 links to “album 1” 314 and “album 2” 315. In an embodiment of the present invention, a photo homepage may include links to one or more photo albums that may include text describing the photo album. Photo albums include links to picture pages that may include text describing the pictures. “Photo album 1” 314 includes “picture 1” 316, “picture 2” 317, and “picture 3” 318. “Photo album 2” 315 includes “picture 4” 319, “picture 5” 320, and “picture 6” 321. “User page 1” 310 also includes a link to “friends info” page 312. “Friends info” page 312 may include identification information for one or more online friends. “User page 1” 310 also includes a link to “blog 1” 313. A blog may allow an authorized user to post entries that one or more other users may read and respond to.

“User page 2” 330 includes a link to “blog 2” 331. “Blog 2” 331 includes “blog entry 1” 332. “Blog entry 1” 332 is linked to “blog entry 2” 333. “Blog entry 2” 333 is linked to “blog entry 3” 334, which in turn is linked to “blog entry 4” 335, which is in turn linked to “blog entry 5” 336.

“User page 3” 340 is linked to “blog 3” 341 and “photo homepage 2” 342. “Photo homepage 2” 342 is linked to “photo album 3” 343. “Photo album 3” 343 is linked to “picture 8” 344, “picture 9” 345, “picture 10” 346, and “picture 11” 347.

“User page 4” 350 is linked to “photo homepage 3” 351, “blog 4” 352, and “contact info homepage” 353. A contact info homepage may include contact information for a user. “Photo homepage 3” 351 is linked to “photo album 4” 354, “photo album 5” 355, and “photo album 6” 356. “Photo album 4” 354 is linked to “picture 12” 357, “picture 13” 358, and “picture 14” 359. “Photo album 5” 355 is linked to “picture 15” 360 and “picture 16” 361. “Photo album 6” 356 is linked to “picture 17” 362, “picture 18” 363, “picture 19” 364, and “picture 20” 365. “Blog 4” 352 is linked to “blog entry 6” 366 and “blog entry 7” 367.

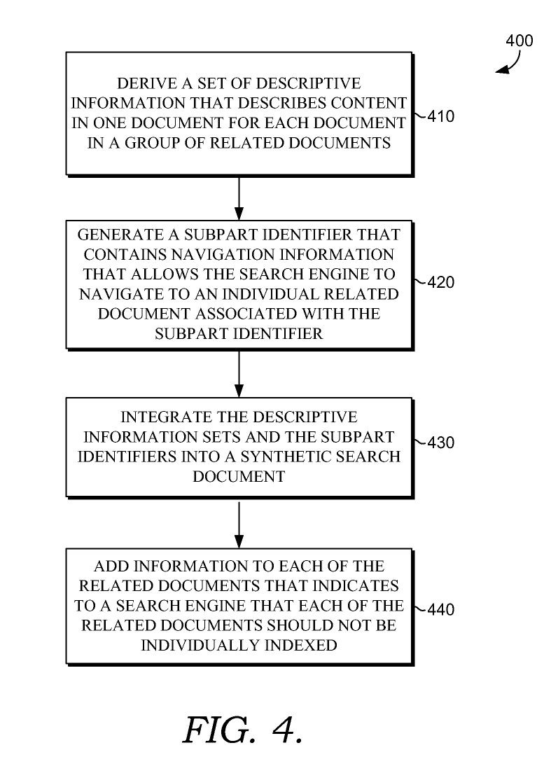

Turning now to FIG. 4, a method 400 of preparing a plurality of related documents to be searched by a search engine is shown according to an embodiment of the present invention. In one embodiment, the related documents are web pages. Method 400 may be practiced by a web server, such as web server 220, that hosts multiple documents that are logically related. The documents may be related by a common subject matter or other characteristic. For example, the documents may all contain blog entries or photo albums. In another embodiment, all of the related documents have a common author or editor. In another embodiment, all of the related documents may be part of a single document hierarchy. Thus, the documents may be related because they all are children documents to a parent node. For example, the root node document could be a homepage and linked pages could be child nodes that are related because they are linked to the homepage. A search engine has been described previously with reference to FIG. 2. Each of the plurality of related documents is reachable by a unique identifier, such as a URL. In an embodiment where the related documents are web pages, each web page may be reached separately by entering an address in a web browser.

At step 410, a set of descriptive information that describes content in one of the plurality of related documents is derived. A set of descriptive information is derived for each of the plurality of related documents resulting in a plurality of descriptive information sets. The descriptive information sets include a separate set of descriptive information for each of the plurality of related documents. In one embodiment, the descriptive information includes text on one of the related documents. The descriptive information could include metadata associated with objects such as videos or photographs on or in a document. For example, a set of descriptive information including a photograph date, a photograph description, and photograph source may be derived from metadata associated with a photograph on a web page. Other text on the web page describing the photograph, such as a caption, may be included in the descriptive information. A set of descriptive information including the text in an article may be derived from a website posting an article. The set of descriptive information describes the document and may include portions of text, and other information from the document.

At step 420, a subpart identifier that contains navigation information that allows a search engine to navigate to an individual related document associated with the subpart identifier is generated. A subpart identifier is generated for each of the plurality of related documents. In one embodiment, a subpart identifier does not contain a URL. Thus, a plurality of subpart identifiers that includes a separate subpart identifier for each of the plurality of related documents is generated. The subpart identifier may provide navigation information to a document in general, or to a portion of a document. Thus, at the conclusion of steps 410 and 420 a set of descriptive information and a corresponding subpart identifier has been generated for each of the related documents.

At step 430, the plurality of descriptive information sets and the plurality of subpart identifiers are integrated into a synthetic search document. A synthetic search document is a single search document that contains multiple subparts. Each subpart includes an individual set of descriptive information paired with a single subpart identifier that contains the navigation information for an individual document from which the individual set of descriptive information is derived. Each subpart corresponds to one of the related documents and includes a set of descriptive information and a subpart identifier.

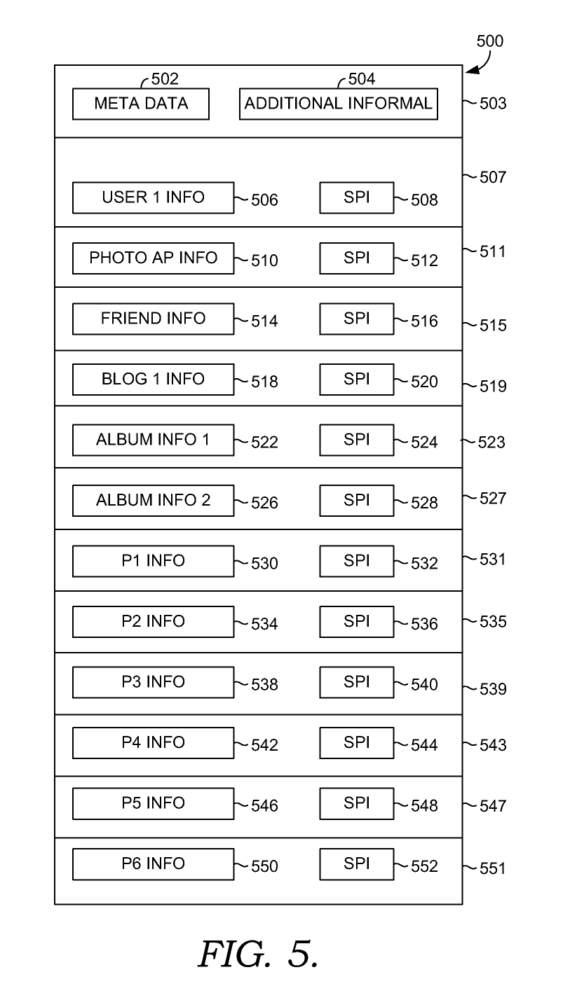

FIG. 5 illustrates a synthetic search document 500 that is generated in accordance with an embodiment of the present invention. Synthetic search document 500 combines descriptive information from “user page 1” 310 with all of the child nodes under “user page 1” 310. This allows all of the web pages in the web page hierarchy headed by “user page 1” 310 to be searched by synthetic search document 500.

Each page in the hierarchy corresponds to a subpart in the synthetic search document 500. “User page 1” 310 corresponds with subpart 507. Subpart 507 includes a set of descriptive information 506 describing “user page 1” 310 and subpart identifier 508 that contains navigation information for “user page 1” 310. Subpart 511 corresponds with “photo homepage 1” 311. Subpart 511 includes a set of descriptive information 510 derived from “photo homepage 1” and a subpart identifier 512 with navigation information to “photo homepage 1” 311. Subpart 515 corresponds with “friend info page” 312. Subpart 515 includes a set of descriptive information 514 describing “friend info page” 312 and subpart identifier 516 that contains navigation information to “friend info page” 312. Subpart 519 corresponds to “blog 1” 313. Subpart 519 includes a set of descriptive information 518 describing “blog 1” 313 and subpart identifier 520 that includes navigation information for “blog 1” 313. Subpart 523 corresponds with “photo album page 1” 314. Subpart 523 includes a set of descriptive information 522 that describes “photo album page 1” 314 and a subpart identifier 524 that contains navigation information to “photo album page 1” 314. Subpart 527 corresponds with “photo album page 2” 315. Subpart 527 includes a set of descriptive information 526 describing “photo album page 2” 315 and subpart identifier 528 that includes navigation information to “photo album page 2” 315. Subpart 531 corresponds to “picture 1” 316. Subpart 531 includes a set of descriptive information 530 describing “picture page 1” 316 and subpart identifier 532 that contains navigation information to “picture page 1” 316. Subpart 535 corresponds to “picture page 2” 317. Subpart 535 includes a set of descriptive information 534 describing “picture page 2” 317 and subpart identifier 536 that has navigation information for “picture page 2” 317. Subpart 539 corresponds with “picture page 3” 318. Subpart 539 includes a set of descriptive information 538 describing “picture page 3” 318 and a subpart identifier 540 that contains navigation information for “picture page 3” 318. Subpart 543 corresponds with “picture page 4” 319. Subpart 543 includes a set of descriptive information 542 describing “picture page 4” 319 and a subpart identifier 544 with navigation information to “picture page 4” 319. Subpart 547 corresponds with “picture page 5” 320. Subpart 547 includes a set of descriptive information 546 describing “picture page 5” 320 and a subpart identifier 548 with navigation information to “picture page 5” 320. Subpart 551 corresponds with “picture page 6” 321. Subpart 551 includes a set of descriptive information 550 describing “picture page 6” 321 and a subpart identifier 552 that includes navigation information to “picture page 6” 321. Thus, synthetic search document 500 includes a set of descriptive information and corresponding subpart identifiers for each picture page 7” in the hierarchy headed by “user page 1” 310.

Synthetic search document 500 also includes a header subpart 503 that includes metadata 502 and supplemental information 504. Metadata 502 may include information that identifies synthetic search document 500 to a search engine as a synthetic search document. Additional metadata information may also be included. Supplemental information 504 may include information that describes each of the documents described in synthetic search document 500. The supplemental information may be used to include additional information that describes the documents consolidated into synthetic search document 500 without modifying the underlying documents. For example, supplemental information 504 may indicate that the synthetic search document 500 is associated with a particular user. The supplemental information 504 may include buddy information indicating one or more buddies associated with user 1.

Returning now to FIG. 4, at step 440 information may be added to each of the plurality of related documents that indicates to a search engine that each of the plurality of related documents should not be individually indexed or searched. This enables the search engine to respond to a query by searching the synthetic search document rather than each of the plurality of related documents. Thus, in the example given with synthetic search document 500, each of pages 310, 311, 312, 313, 314, 315, 316, 317, 318, 319, 320, and 322 would be edited to include an indication that those pages should not be indexed and searched. In one embodiment, the additional information is included as metadata in the edited pages. In one embodiment, a synthetic search document may be updated when a document associated with the synthetic search document is updated. A synthetic search document may be built upon receiving an indication that a search engine is searching one or more documents associated with a web page hosted by a web host.

In one embodiment, related documents within a large group of documents are automatically determined to be related if they contain designated subject matter content. For example, web pages in a social networking site authored by a user and containing photographs could be identified as related. Embodiments of the present invention may be practiced by a website hosting a large number of pages, at least some of which are logically related. The host of the website may publish sitemaps for the synthetic search documents indicating a relationship between synthetic search documents and providing a guideline to a search engine.

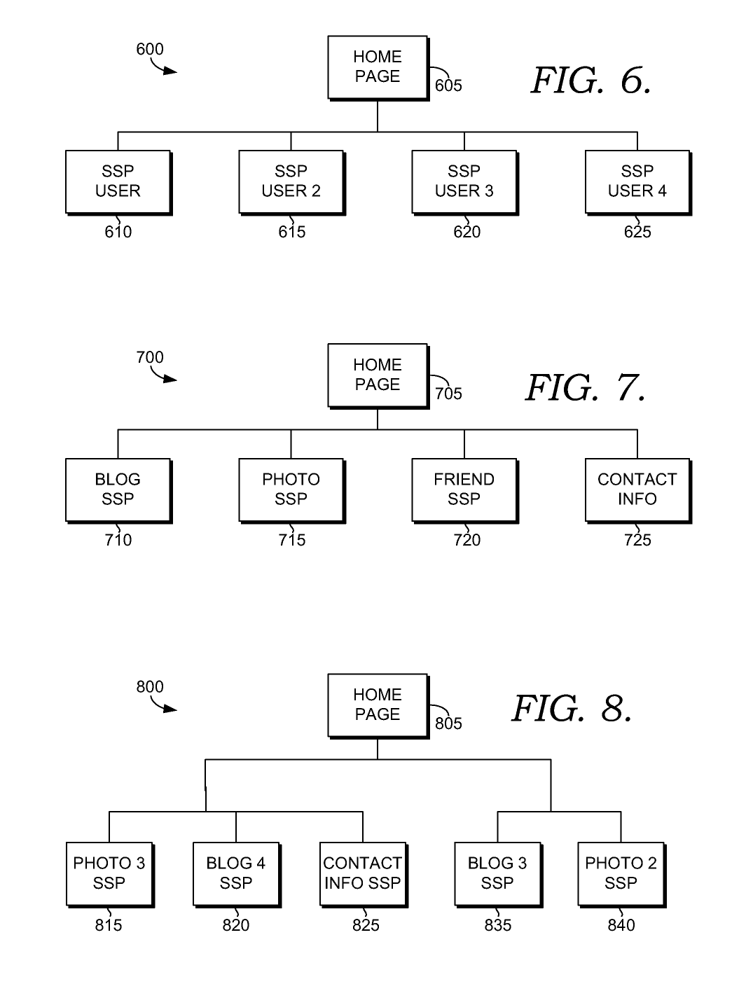

FIGS. 6-8 include example sitemaps showing synthetic search documents created based on the web page hierarchy 300 shown in FIG. 3. FIG. 6 shows a synthetic search document hierarchy wherein the synthetic search documents consolidate pages assigned to a common user. Synthetic search document 610 includes sets of descriptive information describing all documents that are children of “user page 1” 310. Such a synthetic search document was previously illustrated as synthetic search document 500 in FIG. 5. Synthetic search document hierarchy 600 also includes synthetic search document 615, synthetic search document 620, and synthetic search document 625. Synthetic search document 615 consolidates all documents under “user page 2” 330. Synthetic search document 620 consolidates all documents under “user page 3” 340 and synthetic search document 625 consolidates all documents under “user page 4” 350. Synthetic search site map also includes homepage 605, which is not a synthetic search document.

Turning now to FIG. 7, synthetic search document sitemap 700 includes homepage 705, synthetic search document 710, synthetic search document 715, synthetic search document 720, and contact information synthetic search document 725. Synthetic search document 710 groups related blogs and blog entries into a single synthetic search document. The blogs are grouped together without consideration of the user the blog is associated with. For example, synthetic search document 710 could include sets of descriptive information from blog pages 313, 331, 341, and 352, and all entries related to these blog pages. Synthetic search document 715 includes all photo albums and related photo pages. Synthetic search document 720 includes all friend pages. Synthetic search document 725 includes all contact information pages. Thus, the relationship between pages added to a synthetic search document within sitemap 700 does not depend on the user associated with the document. Only the subject matter of the document is considered in determining whether they are related.

Turning now to FIG. 8, a synthetic search document sitemap 800 is shown. Sitemap 800 includes homepage 805, photo album 3 synthetic search document 815, blog 4 synthetic search document 820, contact info search document 825, blog 3 synthetic search document 835, and photo album 2 synthetic search document 840. Photo album 3 synthetic search document 815 includes “photo album homepage 3” 331 and all child pages including pages 354, 357, 358, 359, 355, 360, 361, 356, 362, 363, 364, and 365. Blog 4 synthetic search document 820 includes “blog 4” 352 and pages 366 and 367. Contact info synthetic search document includes page 353. Blog 3 synthetic search document 835 includes “blog 3” 341. Photo album 2 synthetic search document 840 includes pages 342, 343, 344, 345, 346, and 347. Thus, the synthetic search documents shown in FIG. 8 are related by both an associated user and a subject matter.

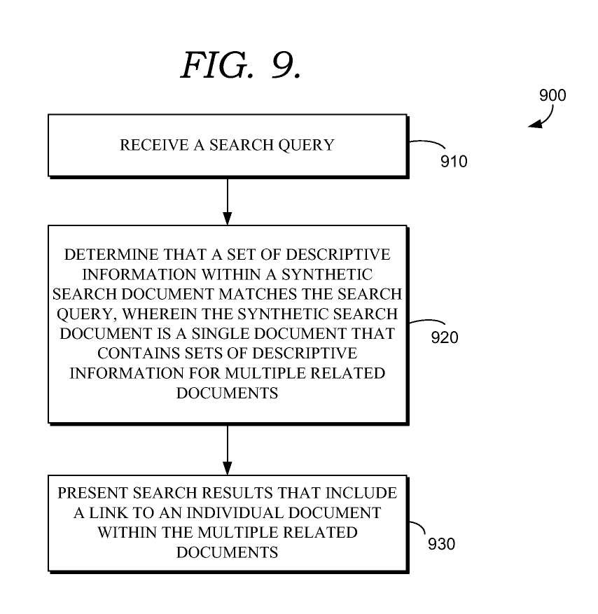

Turning now to FIG. 9, a method 900 of locating information within a plurality of related documents is shown in accordance with an embodiment of the present invention. The plurality of related documents is able to be separately reached by a unique identifier, such as a URL. In one embodiment, method 900 is executed by a search engine. At step 910, a search query is received. A search query may be received through a user interface presented over the Internet. At step 920, a set of descriptive information within a synthetic search document is determined to match the search query. A synthetic search document has been described previously with reference to FIGS. 4 and 5. The synthetic search document may be prepared by a web server in a process apart from method 900. At step 930, search results that include a link to an individual document from which the set of descriptive information is derived is presented. The link is provided by using the navigation information in an individual subpart identifier associated with the set of descriptive information. In one embodiment, upon determining a set of descriptive information matches a search query, the search engine retrieves a synthetic search document containing the set of descriptive information and analyzes the subpart identifier to generate a link to the web page or document summarized in the matching set of descriptive information. The match may be determined by comparing information from the set of descriptive information that was indexed previously by a search engine. In one embodiment, the entire set of descriptive information is not added to an index used by the search engine. Instead, keywords are extracted from the set of descriptive information and added to the index. In one embodiment, the subpart identification information does not include a URL to any of the plurality of related documents. In such a case, the web host and search engine must agree on a protocol for creating a link to the web page based on the information in the subpart identifier.

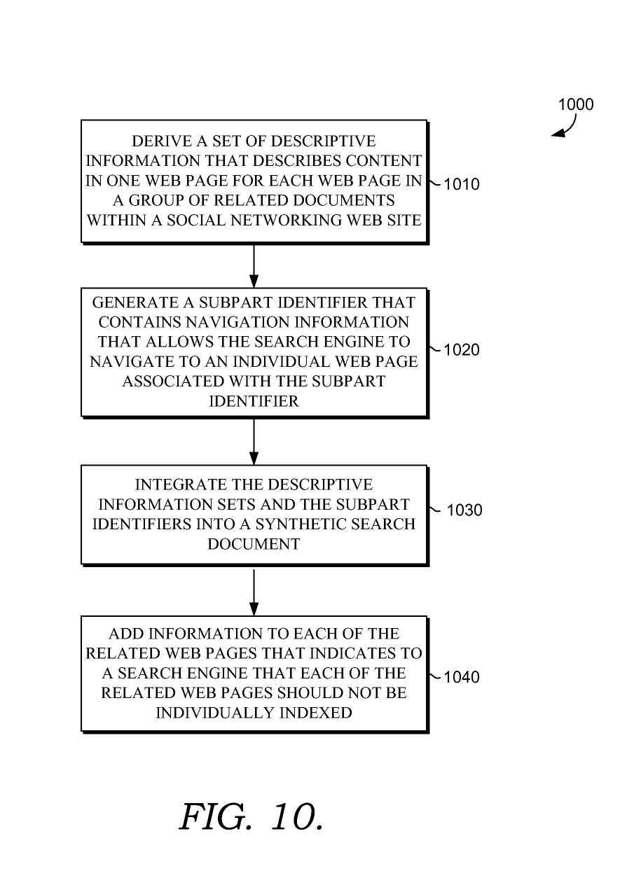

Turning now to FIG. 10, a method 1000 of preparing a plurality of related web pages in a social networking website to be searched by a search engine is shown in accordance with an embodiment of the present invention. Each of the plurality of related websites includes an ability to be separately reached by a unique identifier. A social networking site may contain template pages that present different categories of information related to a user. A social networking site may contain a hierarchical page structure, such as the one illustrated in FIG. 3. Method 1000 may be practiced by a web server that hosts a social networking site that contains many web pages. At step 1010, a set of descriptive information that describes content in one of the plurality of related web pages is derived. A set of descriptive information is derived for each of the plurality of related web pages resulting in a plurality of descriptive information sets. The descriptive information sets include a separate set of descriptive information for each of the plurality of related web pages. In one embodiment, the descriptive information includes text from one of the related web pages. Metadata and HTML tags may be excluded from the descriptive information in embodiments of the present invention. The descriptive information could include metadata associated with objects such as videos or photographs on or in a web page. For example, a set of descriptive information including a photograph date, a photograph description, and photograph source may be derived from metadata associated with a photograph on a web page. Other text on the web page describing the photograph such as a caption, may also be included in the descriptive information.

At step 1020, a subpart identifier that contains navigation information that allows a search engine to navigate to an individual web page associated with the subpart identifier is generated. A subpart identifier is generated for each of the plurality of related web pages. In one embodiment, a subpart identifier does not contain a URL. Thus, a plurality of subpart identifiers that includes a separate subpart identifier for each of the plurality of related web pages is generated. The subpart identifier may provide navigation information to a web page in general, or to a portion of a web page.

At step 1030, the plurality of descriptive information sets and the plurality of subpart identifiers are integrated into a synthetic search document. A synthetic search document is a single search document that contains multiple subparts. Each subpart includes an individual set of descriptive information paired with a single subpart identifier that contains the navigation information for an individual web page from which the individual set of descriptive information is derived. A synthetic search document has been described previously with reference to FIG. 5.

At step 1040, information may be added to each of the plurality of related web pages that indicates to a search engine that each of the plurality of related web pages should not be individually indexed. This enables the search engine to respond to a query by searching the synthetic search document rather than each of the plurality of related web pages. Step 1040 helps prevent the search engine from indexing duplicate information. Avoiding duplicate indexing may be prevented using or methods.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of preparing a plurality of related documents to be searched by a search engine, wherein each of the plurality of related documents is reachable by a unique identifier, the method comprising:
for each of the plurality of related documents, deriving a set of descriptive information that describes content in one of the plurality of related documents, thereby resulting in a plurality of descriptive information sets that includes a separate set of descriptive information for each of the plurality of related documents;
for each of the plurality of related documents, generating a subpart identifier that contains navigation information that allows the search engine to navigate to an individual related document associated with the subpart identifier, wherein the subpart identifier does not contain a URL, thereby resulting in a plurality of subpart identifiers that includes a separate subpart identifier for each of the plurality of related documents; and
integrating the plurality of descriptive information sets and the plurality of subpart identifiers into a synthetic search document, wherein the synthetic search document is a single document that contains multiple subparts, wherein each subpart includes an individual set of descriptive information paired with a single subpart identifier that contains the navigation information for an individual document from which the individual set of descriptive information is derived, thereby enabling the search engine to respond to a query by searching said synthetic search document rather than each of the plurality of related documents.

2. The media of claim 1, wherein the synthetic search document includes identification data that indicates to the search engine that the synthetic search document is the synthetic search document.

3. The media of claim 1, wherein each of the plurality of related documents is related by a common category of subject matter content.

4. The media of claim 3, wherein the method further comprises automatically identifying the plurality of related documents from a larger group of documents by determining that each of the plurality of related documents has content within the common category.

5. The media of claim 1, wherein the method further includes adding information to each of the plurality of related documents that indicates to the search engine that each of the plurality of related documents should not be individually indexed.

6. The media of claim 5, wherein the plurality of related documents includes pages associated with a social networking web site.

7. The media of claim 1, wherein the method further includes adding supplemental information to the synthetic search document that describes each of the plurality of related documents, wherein said supplemental information is not found in one or more of said plurality of related documents, thereby allowing the supplemental information to be associated with each of the plurality of related documents for searching purposes without modifying each of the plurality of related documents.

8. The media of claim 1, wherein the method further includes generating the synthetic search document upon receiving an indication that the search engine is preparing to search the plurality of related documents.

9. One or more computer-readable media having computer-executable instructions embodied thereon for performing a method of locating information within a plurality of related documents, wherein each of said plurality of related documents includes an ability to be separately reachable by a unique identifier, the method comprising:
receiving a search query;
determining that a set of descriptive information within a synthetic search document matches the search query, wherein the synthetic search document is a single document that contains a subpart for each of the plurality of related documents, thereby forming a plurality of subparts, wherein each subpart includes an individual set of descriptive information that describes content in one related document and an associated subpart identifier that contains navigation information that allows a search engine to navigate to the one related document; and
presenting search results that include a link to an individual document from which said set of descriptive information is derived by using the navigation information in an individual subpart identifier associated with the set of descriptive information to generate the link.

10. The method of claim 9, wherein the synthetic search document does not include a URL to any of the plurality of related documents.

11. The method of claim 9, wherein the plurality of related documents includes web pages hosted in a single domain.

12. The method of claim 9, wherein the method further includes identifying meta data on each of the plurality of related documents that indicates each of the plurality of related documents should not be individually indexed.

13. The method of claim 9, wherein the method further includes adding supplemental information to the synthetic search document that describes each of the plurality of related documents, wherein said supplemental information is not found in one or more of said plurality of related documents, thereby allowing the supplemental information to be associated with each of the plurality of related documents for searching purposes without modifying each of the plurality of related documents.

14. One or more computer-readable media having computer-executable instructions embodied thereon for performing a method of preparing a plurality of related web pages in a social networking web site to be searched by a search engine, wherein each of the plurality of related web pages includes an ability to be separately reachable by a unique identifier, the method comprising:
for each of the plurality of related web pages in the social networking web site, deriving a set of descriptive information that describes content in one of the plurality of related web pages, thereby resulting in a plurality of descriptive information sets that includes a separate set of descriptive information for each of the plurality of related web pages, wherein each of the plurality of related web pages include a common subject matter;
for each of the plurality of related web pages, generating a subpart identifier that contains navigation information that allows the search engine to navigate to an individual related web page associated with the subpart identifier, thereby resulting in a plurality of subpart identifiers that includes a separate subpart identifier for each of the plurality of related web pages; and
integrating the plurality of descriptive information sets and the plurality of subpart identifiers into a synthetic search document, wherein the synthetic search document is a single document that contains multiple subparts, wherein each subpart includes an individual set of descriptive information paired with a single subpart identifier that contains the navigation information for an individual web page from which the individual set of descriptive information is derived, thereby enabling the search engine to respond to a query by searching said synthetic search document rather than each of the plurality of related web pages.

15. The media of claim 14, wherein the plurality of related web pages includes one or more hierarchical levels of child web pages under a root web page.

16. The media of claim 14, wherein the method further includes updating synthetic search document after one or more individual web pages within the plurality of related web pages is updated.

17. The media of claim 14, wherein each of the plurality of related web pages is associated with a common user of the social networking web site.

18. The media of claim 14, wherein the common subject matter includes at least one of blog entries, digital photographs, videos, contact information, a single photo album.

19. The media of claim 14, wherein the method further includes adding supplemental information to the synthetic search document that describes each of the plurality of related web pages, wherein said supplemental information is not found in one or more of the plurality of related web pages, thereby allowing the supplemental information to be associated with each of the plurality of related web pages for searching purposes without modifying each of the plurality of related web pages.

20. The media of claim 14, wherein the method further includes adding information to each of the plurality of related web pages that indicates to the search engine that each of the plurality of related web pages should not be individually indexed.
